(19) United States
(12) Patent Application Publication
(10) Pub. No.: US 2004/0130657 A1
(43) Pub. Date: Jul. 8, 2004

(54) Digital camera

(76) Inventor: Joe Hsu, Yung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/337,334

(22) Filed: Jan. 7, 2003

(51) Int. Cl. H04N 5/225

(52) U.S. Cl. 348/375

(57) ABSTRACT

A digital camera includes a casing accommodating electrical and optic parts of the camera therein. The casing has a handle having a contour that can be held by a single hand. The casing forms a front face and defines a recess in a read side thereof. A view-finding window and a lens are mounted to the front face. An eyepiece is mounted to the rear side of the casing. A release button is formed on the front face and substantially opposite to the recess whereby when a hand holds the handle, the thumb of the hand is positioned on the recess to further fix the camera and the finger index can access and thus actuate the release button. A holder having a receptacle for receiving a lower end of the handle is also provided to support the camera in a stand-along fashion. The holder includes a clip for attaching the holder, together with the camera, to a fixture. The camera may be provided with a liquid crystal display and a flash unit. If desired, a carrying strip can be attached to the casing for user's carrying the camera.

### BACKGROUND OF THE INVENTION

1. Field of the Invention

The present invention relates generally to a digital camera, and in particular to a digital camera capable of one hand operation.

2. Description of the Prior Art

A digital camera is commonly made in the form of a “box” having a front face on which a viewfinder is formed. An eyepiece is formed on a rear face. A release button is formed on a top side of the box-like camera. The camera is usually held by both hands of a user, with one of his or her fingers, usually an index finger, accessing and actuating the release button to take picture found by the viewfinder. The box-like configuration of the conventional digital camera makes it necessary for the user to hold the camera with both hands.

Digital cameras with a compact configuration capable to be held by one single hand are also available. However, they cannot be operated with one single hand. In other words, although they can be held by one hand, the actuation of the release button is done with the other hand.

Furthermore, the compact size digital cameras are designed for easy carrying. Due to the compact size, it is difficult to place the compact size digital camera on a fixture in a stand-along manner.

It is thus desired to provide a digital camera for overcoming the above deficiencies of the conventional digital cameras.

### SUMMARY OF THE INVENTION

Thus, an object of the present invention is to provide a digital camera capable of operation with one single hand.

Another object of the present invention is to provide a digital camera with an accessory to form a stand-along device.

To achieve the above objects, in accordance with the present invention, there is provided a digital camera comprising a casing accommodating electrical and optic parts of the camera therein. The casing has a handle having a contour that can be held by a single hand. The casing forms a front face and defines a recess in a read side thereof. A view-finding window and a lens are mounted to the front face. An eyepiece is mounted to the rear side of the casing. A release button is formed on the front face and substantially opposite to the recess whereby when a hand holds the handle, the thumb of the hand is positioned on the recess to further fix the camera and the finger index can access and thus actuate the release button. A holder having a receptacle for receiving a lower end of the handle is also provided to support the camera in a stand-along fashion. The holder includes a clip for attaching the holder, together with the camera, to a fixture. The camera may be provided with a liquid crystal display and a flash unit. If desired, a carrying strip can be attached to the casing for user's carrying the camera.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a digital camera constructed in accordance with the present invention supported by a holder as a stand-along device;

FIG. 2 is similar to FIG. 1 but showing the digital camera detached from the holder;

FIG. 3 is a perspective view of the digital camera showing a rear side thereof;

FIG. 4 is similar to FIG. 3 but showing a data transmission cable connected to the digital camera;

FIG. 5 is a perspective view showing the operation of the camera with one single hand;

FIG. 6 is another perspective view of the digital camera to which a carrying strip is attached;

FIG. 7 is a perspective view showing the digital camera with the carrying strip supported by the holder;

FIG. 8 is a perspective view of a digital camera constructed in accordance with another embodiment of the present invention; and

FIG. 9 is a perspective view of a digital camera constructed in accordance with a further embodiment of the present invention.

### DETAILED DESCRIPTION OF THE PREFERRED EMBODIMENTS

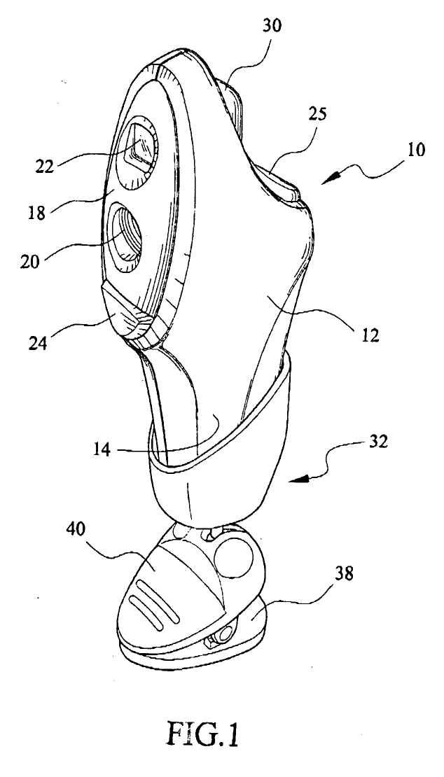

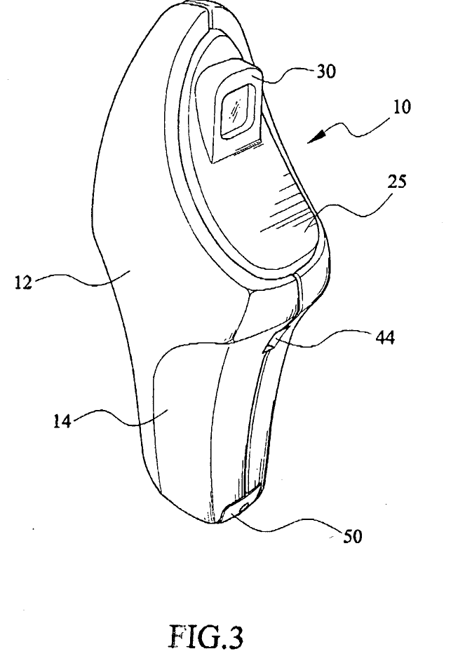

With reference to the drawings and in particular to FIGS. 1-3, a digital camera constructed in accordance with the present invention, generally designated with reference numeral 10, comprises a casing 12 in which optic and electrical parts for the operation of taking and storing pictures are accommodated. The optic and electrical parts are well known in the art and will not be described in detail unless they are required for the description and understanding of the present invention.

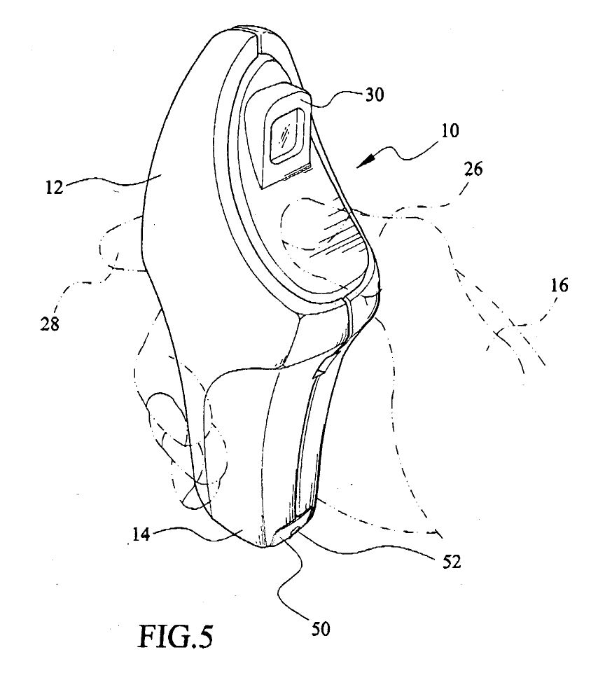

The casing 12 of the digital camera 10 comprises a handle portion 14 having a contour suitable for holding by a single hand 16 as indicated by phantom lines of FIG. 5. The casing 12 forms a front face 18 on which a lens 20 and a view-finding window 22 are mounted. A release button 24 is mounted on the front face 18 adjacent the lens 20. On a rear side of the casing 12, a recess 25 is defined, substantially opposite to the front face 18 for supporting a thumb 26 of the hand 16 at a position substantially corresponding to the release button 24. Thus, when the hand 16 holds the handle 14 of the camera 10, the thumb 26 can be positioned on the recess 25 while the index finger 28 can access and thus actuate the release button 24. One hand operation of the camera 10 is thus realized.

An eyepiece 30 is provided in the recess 25 for visual view finding.

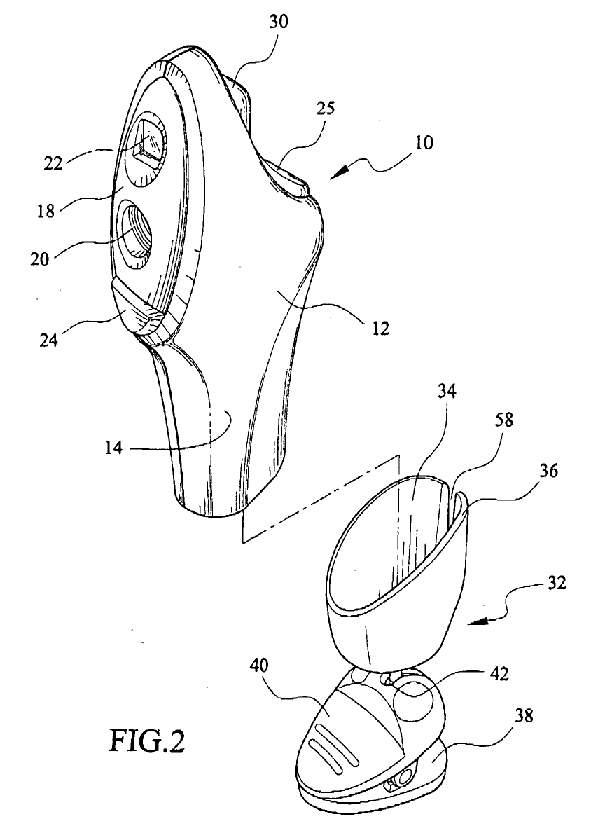

As shown in FIGS. 1 and 2, a holder 32 is provided for holding the camera 10 as a stand-along device. The holder 32 comprises a receptacle 34 defined by a surrounding wall 36 and configured for receiving a lower end portion of the handle 14 of the camera 10. The holder 32 also comprises a base 38 for positioning on a fixture (not shown). A clip member 40 is mounted to the base 38 for forming a clip that releasably attaches the holder 32 to a fixture (not shown). The receptacle 34 is mounted to the clip member 40 by a post 42 that is in turn connected to the clip member 40 by a joint, such as spherical joint for rotation of the receptacle 34 with respect to the base 38.

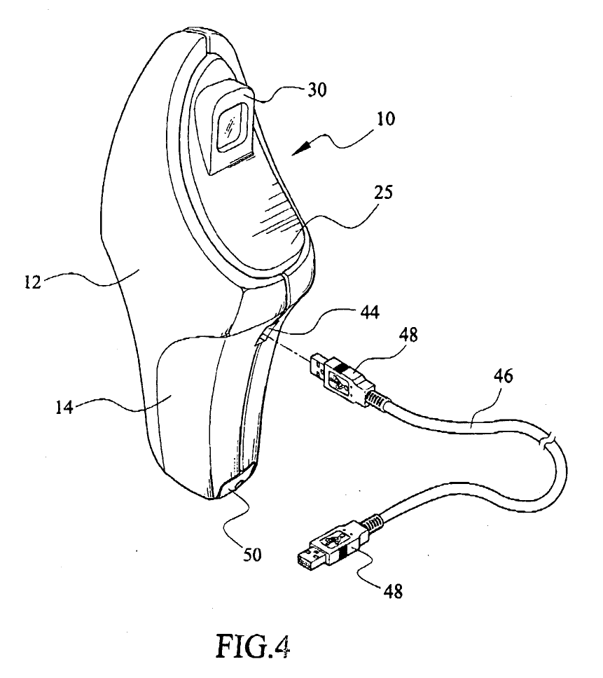

Also referring to FIG. 4, a connection port 44 is defined in the casing 12 for removable connection with a data communication cable 46 to establish communication with an external device, such as a computer (not shown). In the embodiment illustrated, the cable 46 has two ends both forming electrical connectors 48, such as USB (Universal Serial Bus) connectors. Thus, the connection port 44 is a USB based connector mateable with the end connector 48 of the cable 46.

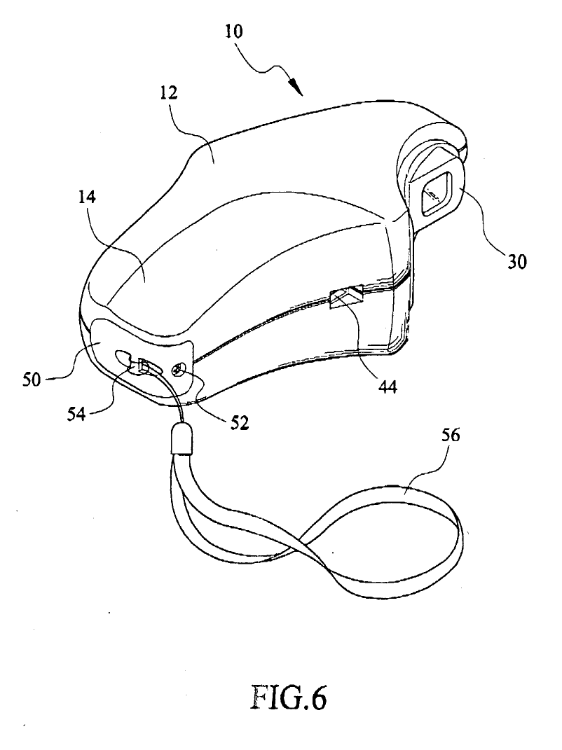

Also referring to FIG. 6, the casing 12 defines a battery chamber (not shown) selectively closed by a lid 50. The lid 50 is secured to the casing 12 by a bolt 52 which can be removed to expose the battery chamber for depositing battery (not shown) into the chamber or replacing battery inside the chamber.

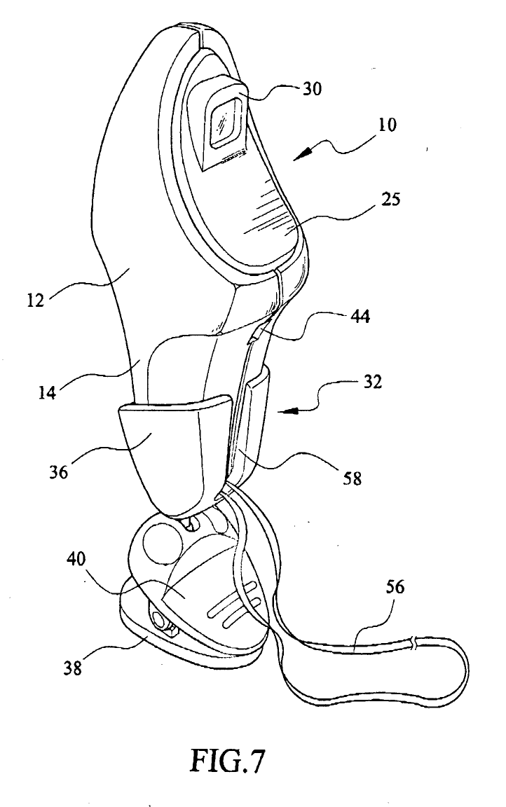

Also referring to FIG. 7, the lid 50 forms a hanging bar 54 to which a carrying strip 56 is attached for user's readily carrying the camera 10. To accommodate the carrying strip 56, the wall 36 of the receptacle 34 of the holder 32 defines a slit 58 through which the strip 56 extends when the camera 10 is received in and held by the holder 32.

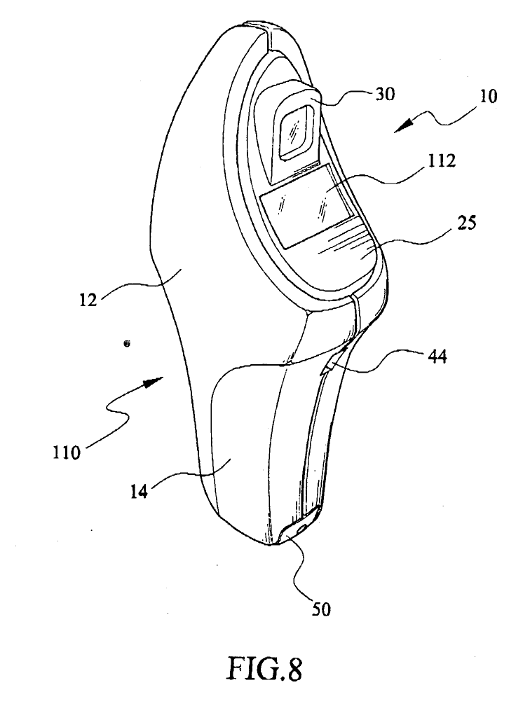

FIG. 8 shows another embodiment of the camera in accordance with the present invention, which is designated with reference numeral 110 for distinction. The digital camera 110 is substantially identical to the digital camera 10 with reference to FIGS. 1-7 and is further provided with a liquid crystal display 112 for observation of the view taken by the camera 110. The remaining portions of the camera 110 are substantially identical to those of the camera 10 and will thus not be repeatedly described.

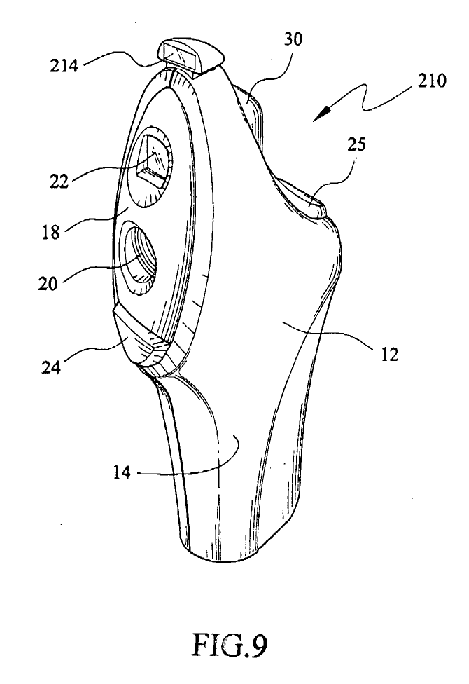

Similarly, FIG. 9 shows a further embodiment of the camera in accordance with the present invention, which is designated with reference numeral 210 for distinction. The digital camera 210 is substantially identical to the digital camera 10 with reference to FIGS. 1-7 and is further provided with a flash unit 214 for providing background light in taking pictures. The remaining portions of the camera 210 are substantially identical to those of the camera 10 and will thus not be repeatedly described.

Although the present invention has been described with reference to the preferred embodiments thereof, it is apparent to those skilled in the art that a variety of modifications and changes may be made without departing from the scope of the present invention which is intended to be defined by the appended

What is claimed is:

1. A digital camera comprising:
a casing adapted to accommodate electrical and optic parts therein, the casing comprising a handle having a contour holdable by a single hand, the casing forming a front face and a rear recess; and
a release button formed on the front face and substantially opposite to the recess whereby thumb of the hand is positionable on the recess with the release button accessible by index finger of the hand.

2. The digital camera as claimed in claim 1 further comprising a holder comprising a receptacle into which a lower end of the handle is receivable whereby the digital camera is supported as a stand-along device.

3. The digital camera as claimed in claim 2, wherein the holder comprises a base adapted to be positioned on a fixture.

4. The digital camera as claimed in claim 3, wherein the holder comprises a clip member movably attached to the base to form a clip adapted to attach the holder to a fixture.

5. The digital camera as claimed in claim 2, wherein the receptacle is movably mounted to the base.

6. The digital camera as claimed in claim 1, wherein a view-finding window is formed on the front face and a corresponding eyepiece is formed on a rear side of the casing.

7. The digital camera as claimed in claim 1, wherein a lens is mounted to the front face of the casing adjacent the release button.

8. The digital camera as claimed in claim 1 further comprising a carrying strip attached to the casing.

9. The digital camera as claimed in claim 1 further comprising a display formed on the casing.

10. The digital camera as claimed in claim 9, wherein the display comprises a liquid crystal display.

11. The digital camera as claimed in claim 1 further comprising a flash unit mounted to the casing.
